(19) United States
(12) Patent Application Publication
(10) Pub. No.: US 2016/0265243 A1
(43) Pub. Date: Sep. 15, 2016

(54) BOILER SUPPORT STRUCTURE

(71) Applicant: MITSUBISHI HITACHI POWER SYSTEMS, LTD., Yokohama-shi, Kanagawa (JP)

(72) Inventors: Masaki SHIMONO, Tokyo (JP); Kunihiro MORISHITA, Tokyo (JP); Motoki KATO, Tokyo (JP); Yuji KURODA, Tokyo (JP); Tatsuya AMANO, Tokyo (JP); Keiichi MORITSUKA, Tokyo (JP)

(21) Appl. No.: 15/031,829

(22) PCT Filed: Dec. 22, 2014
(86) PCT No.: PCT/JP2014/006380

§ 371 Date: Apr. 25, 2016

(30) Foreign Application Priority Data
Dec. 24, 2013 (JP) 2013-265598

(51) Int. Cl. E04H 9/02; E04H 5/02; F16F 15/02; F22B 37/24

(52) U.S. Cl. CPC E04H 9/02; F22B 37/24; E04H 5/02; F16F 15/02

(57) ABSTRACT

A boiler support structure is provided that is capable of significantly reducing an effect of a seismic force and also capable of vibrating integrally during an earthquake. The boiler support structure is provided with a main boiler body (3), a support steel frame (11) that supports the main boiler body (3) in a suspended state and that includes a plurality of pillars (11a) that each stand on a foundation (1) with a pillar legs (11b) placed therebetween and a plurality of beams (11c) that connect the adjacent pillars (11a), and seismic isolation devices (5) that support the plurality of respective pillars (11a). In the boiler support structure (10), seismic isolation characteristics of each of the seismic isolation devices (5) are set in accordance with horizontal reaction forces occurring in the plurality of pillar legs (11b).

### TECHNICAL FIELD

The present invention relates to a structure for supporting a boiler in a suspended state, and particularly relates to a boiler support structure provided with a seismic isolation device.

### BACKGROUND ART

Large boilers, such as a coal-fired power generation boiler and a heavy oil-fired boiler, are normally supported by a support steel frame, along with other accessory devices including a NOx removal device, an air heater, and the like.

With respect to the boiler support structure, for the purpose of achieving seismic isolation, Patent Document 1 proposes that in a portion above the center of gravity of a main boiler body, the main boiler body and a support steel frame are connected together by members having low rigidity, and in a portion below the center of gravity of the main boiler body, the main boiler body and the support steel frame are connected together by members having high rigidity. This proposal proposes a structure in which the support structure of the lower portion, which has high rigidity, suppresses excessive relative displacement between the main boiler body and the support steel frame during an earthquake, and the support structure of the upper portion, which has low rigidity, does not transmit vibrations of the boiler support steel frame occurring due to an earthquake to the main boiler body. By doing so, in Patent Document 1, an effect of a seismic force on the entire boiler support steel frame is reduced.

### CITATION LIST

### Patent Literature

Patent Literature 1: Japanese Unexamined Patent Application Publication No. H02-15060A

### SUMMARY OF INVENTION

### Technical Problem

However, according to the proposal disclosed in Patent Document 1, a reduction of the seismic force in the lower portion of the main boiler body cannot be expected. Thus, there is a problem that the effect of reducing the seismic force is small with respect to the entire boiler support structure.

An object of the present invention is to provide a boiler support structure capable of significantly reducing the effect of a seismic force on the boiler support structure and capable of vibrating integrally during an earthquake.

### Solution to Problem

A boiler support structure according to the present invention includes a main boiler body; a support steel frame that supports the main boiler body in a suspended state and that includes a plurality of pillars that each stand on a foundation with a pillar leg placed therebetween, and a plurality of beams that connect the adjacent pillars; and a seismic isolation device that supports at least one of the plurality of pillars. Seismic isolation characteristics of the seismic isolation device are set in accordance with magnitudes of horizontal reaction forces occurring in the plurality of pillars.

According to the present invention, since each of the pillars is supported by the seismic isolation device, it is possible to significantly reduce an effect of a seismic force and also to cause the support structure to vibrate integrally during an earthquake. Thus, an effect of seismic isolation is high.

Here, rigidity and proof stress can be given as the seismic isolation characteristics of the present invention. Specifically, in the present invention, the seismic isolation device that has high rigidity or proof stress is arranged in a location at which a horizontal reaction force occurring in the pillar is large, and the seismic isolation device that has low rigidity or proof stress is arranged in a location at which the horizontal reaction force occurring in the pillar is small.

In the support structure according to the present invention, the positions in which the seismic isolation device is provided are categorized into a first aspect, a second aspect, and a third aspect.

In the first aspect, the seismic isolation device is provided between the foundation and the pillar leg of the pillar.

According to the first aspect, it becomes possible to seismically isolate the main boiler body positioned above the seismic isolation device and the entire support structure, and an effect of the seismic force on the support steel frame can be significantly reduced. Further, the support structure can vibrate integrally during an earthquake, and this contributes to improving the effect of the seismic isolation.

Next, in the second aspect, the seismic isolation device is provided in an intermediate region, in a height direction, of the support steel frame.

The support structure that supports the main boiler body is a top heavy structure in which a support load tends to become larger toward an upper portion. Thus, the effect of reducing the seismic force can be sufficiently obtained even with the second embodiment in which only the upper portion is seismically isolated by providing the intermediate seismic isolation device.

Further, by providing the seismic isolation device in a position higher than the pillar leg, an arm length h of an overturning moment M of the seismic isolation device, which arises due to an inertia force occurring during an earthquake, can be shortened. As a result, a tensile force occurring in the seismic isolation device is reduced, and it becomes possible to apply the seismic isolation device to a boiler support structure that has a large overturning moment M during an earthquake, such as a large boiler.

Next, in the third aspect, the seismic isolation device is provided in a top portion of the support steel frame.

The support steel frame supports the main boiler body in a suspended state in its top portion. Thus, by installing the seismic isolation device in the top portion, it becomes possible to reduce the inertia force of the main boiler body that acts upon the support steel frame during an earthquake. In particular, when the boiler support structure is not provided with any support, all of the inertia force of the main boiler body is transmitted to the support steel frame via the upper portion of the support structure above the seismic isolation device. Thus, since it is possible to reduce the inertia force of the main boiler body that is transmitted to the support steel frame by seismically isolating the top portion in the third aspect, an effect of a seismic load on the support steel frame can be reduced.

Further, since a position of the seismic isolation device is even higher in the third aspect than in the second aspect, the arm length h becomes shorter, and thus, the overturning moment M occurring in the seismic isolation device during the earthquake is further reduced. As a result, it becomes possible to apply the seismic isolation device to the support steel frame in which the overturning moment M is very large.

In the first to third aspects, it is preferable that a rigid member for securing a horizontal rigidity of the pillar leg be installed in a specific section or an entire section of the support steel frame.

In the first aspect, by providing the rigid member, it becomes possible to secure the horizontal rigidity of the support steel frame positioned above the seismic isolation device, and it becomes easier to obtain a vibration mode in which the entire boiler support structure above the seismic isolation device vibrates integrally. As a result, the effect of the seismic isolation can be further improved.

Here, as the rigid member, a connecting beam that connects the pillar legs, a horizontal brace, and a slab that is laid between the pillar legs can be used.

Further, the rigid member can be installed in a selected specific section. In this case, a section in which the rigid member is not provided can be used as a space for installing equipment or transporting materials, or as a space through which people can enter and exit. Thus, it is possible to obtain the seismically isolated boiler support structure without having a negative impact on a plant operation.

On the other hand, when the rigid member is installed in the entire region of the support steel frame in the horizontal direction, a higher level of horizontal rigidity can be secured. Thus, it becomes easier to obtain a vibration mode that causes the entire boiler support structure to vibrate in a more integral manner.

Further, this rigid member can also be applied to the second aspect and the third aspect, as well as to the first aspect.

In the second aspect and the third aspect, a displacement suppression member (a support) for suppressing a relative displacement between the main boiler body and the support steel frame can be installed between the main boiler body and the support steel frame.

By suppressing the relative displacement, it is possible to prevent any impact on peripheral equipment of the main boiler body.

Further, as a result of shortening a cycle of a natural frequency of the main boiler body by installing the displacement suppression member, it is possible to prevent the natural frequency of the main boiler body and the natural frequency of the entire seismically isolated boiler support structure from becoming close to each other. Thus, the effect of the seismic isolation in the support structure can be sufficiently exploited.

In the second aspect and the third aspect, an energy absorption mechanism can be installed between the main boiler body and the support steel frame in the boiler support structure according to the present invention.

In the boiler support structure, a damping function is imparted by installing the energy absorption mechanism. As a result, it becomes possible to suppress an excessive relative displacement between the main boiler body and the support steel frame, and at the same time, the inertia force of the main boiler body in the horizontal direction, which acts upon the support steel frame during an earthquake, can be further reduced.

It is preferable that a pull-out prevention mechanism that bears a tensile force occurring in the seismic isolation device be installed in the first aspect and the second aspect along with the seismic isolation device.

As a result of the pull-out prevention mechanism bearing the tensile force occurring in the seismic isolation device during an earthquake, the tensile force occurring in the seismic isolation device is reduced. As a result, it becomes possible to apply the seismic isolation device to a structure that has a large overturning moment during an earthquake, such as a large boiler.

It is preferable that an energy absorption mechanism be installed in the first aspect and the second aspect along with the seismic isolation device.

As a result of imparting a damping effect on the boiler support structure by providing the energy absorption mechanism, it is possible to further reduce the seismic force that acts upon the support steel frame, and it is also possible to suppress the excessive displacement from occurring in the seismic isolation device during the earthquake.

### ADVANTAGEOUS EFFECTS OF INVENTION

According to the present invention, a boiler support structure can be provided that can significantly reduce an effect of a seismic force and that can also vibrate integrally during an earthquake.

### BRIEF DESCRIPTION OF DRAWINGS

FIGS. 1A and 1B illustrate a boiler support structure according to a first embodiment, FIG. 1A is a side view thereof, and FIG. 1B is a cross-sectional view taken along A-A of FIG. 1A.

FIGS. 2A and 2B illustrate the A-A cross section of the support structure in FIGS. 1A and 1B, FIG. 2A illustrates a case in which seismic isolation devices have not yet been adjusted, and FIG. 2B illustrates a case in which the seismic isolation devices have been adjusted.

FIGS. 3A and 3B illustrate a boiler support structure according to a second embodiment, FIG. 3A is a side view thereof, and FIG. 3B is a cross-sectional view taken along B-B of FIG. 3A.

FIGS. 4A and 4B illustrate another boiler support structure according to the second embodiment, FIG. 4A is a side view thereof, and FIG. 4B is a cross-sectional view taken along B-B of FIG. 4A.

FIGS. 5A and 5B illustrate another boiler support structure according to the second embodiment, FIG. 5A is a side view thereof, and FIG. 5B is a cross-sectional view taken along B-B of FIG. 5A.

FIGS. 6A and 6B illustrate another boiler support structure according to the second embodiment, FIG. 6A is a side view thereof, and FIG. 6B is a cross-sectional view taken along B-B of FIG. 6A.

FIG. 7 is a side view illustrating a boiler support structure according to a third embodiment.

FIG. 8 is a side view illustrating a boiler support structure according to a fourth embodiment.

FIG. 9 is a side view illustrating another boiler support structure according to the fourth embodiment.

FIGS. 10A and 10B are side views illustrating another boiler support structures according to the fourth embodiment.

FIG. 11A to 11E are diagrams illustrating pull-out prevention mechanisms that are applied to the first embodiment and the second embodiment.

FIG. 12A to 12C are diagrams illustrating energy absorption mechanisms that are applied to the first to third embodiments.

### DESCRIPTION OF EMBODIMENTS

The present invention will be described below in detail on the basis of embodiments illustrated in the attached drawings.

### First Embodiment

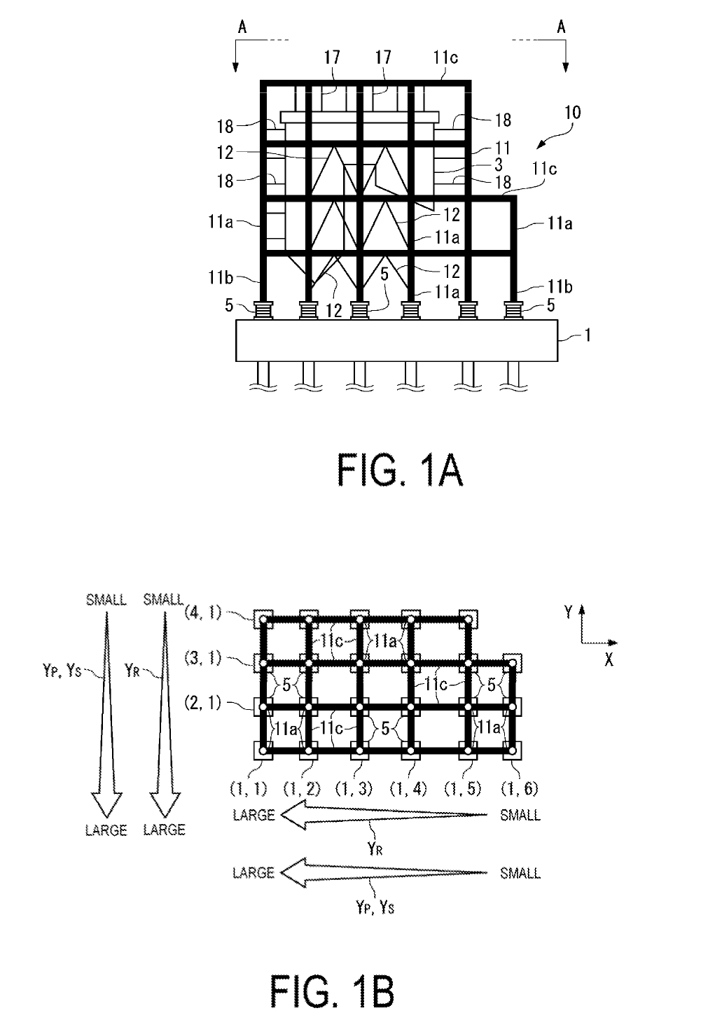

A boiler support structure 10 according to a first embodiment is provided on a foundation 1 as illustrated in FIG. 1A. The boiler support structure 10 mainly includes a support steel frame 11, and a plurality of seismic isolation devices 5 that support the support steel frame 11. The boiler support structure 10 supports a main boiler body 3.

The support steel frame 11 is formed by combining a plurality of pillars 11a extending in a vertical direction, a plurality of beams 11c extending in a horizontal direction, and a plurality of vertical braces 12. The boiler support structure 10 stands on the foundation 1 with pillar legs 11b placed there between. The pillar legs 11b are end portions of the pillars 11a that form the support steel frame 11.

The boiler support structure 10 suspends a main boiler body 3 from a top portion of the support steel frame 11 via a plurality of suspension bars 17 that are fixed to the uppermost beam 11c so as not to restrict thermal expansion during operation. In order to regulate displacement of the main boiler body 3 in the horizontal direction, the boiler support structure 10 has supports 18 interposed between the main boiler body 3 and the outermost pillars 11a of the support steel frame 11. The supports 18 extend between the main boiler body 3 and the outermost pillars 11a in the horizontal direction.

The boiler support structure 10 has the seismic isolation devices 5 installed between the base portions of the respective pillars legs 11b and the foundation 1, as illustrated in FIG. 1A and FIG. 1B.

In the present embodiment, seismic isolation characteristics of each of the seismic isolation devices 5 are set in accordance with magnitudes of horizontal reaction forces (hereinafter simply referred to as pillar leg reaction forces) that occur in the pillar legs 11b as a result of the seismic force acting upon the support steel frame 11, and all the seismic isolation devices 5 are set so as to behave in synchrony with each other. Specifically, as illustrated in FIG. 1B, the seismic isolation devices 5 that have high rigidities Y_{S} are installed in locations at which the pillar leg reaction forces Y_{R} are large, and the seismic isolation devices 5 that have low rigidities Y_{S} are installed in locations at which the pillar leg reaction forces Y_{R} are small. FIG. 1B illustrates a correspondence between the pillar leg reaction force Y_{R} in a Y-axis direction of FIG. 1B and the rigidity Yₛ of the seismic isolation device 5. As illustrated by arrows in FIG. 1B, from one side toward the other, the pillar leg reaction force Y_{R} becomes larger, and the corresponding rigidity Yₛ of the seismic isolation device 5 is set to become larger. Note that, when a set of the pillar legs 11b is expressed as a matrix by assigning signs (1, 1) . . . to each of the pillar legs 11b, as illustrated in FIG. 1B, the pillar leg reaction force Y_{R} of the pillar leg 11b corresponding to (1, 1) is the largest, and the pillar leg reaction forces Y_{R} become smaller in the order of (1, 2), (1, 3) . . . and also in the order of (2, 1), (3, 1) . . . .

A reason for causing the rigidities of the seismic isolation devices 5 to be different from each other as described above will be explained below.

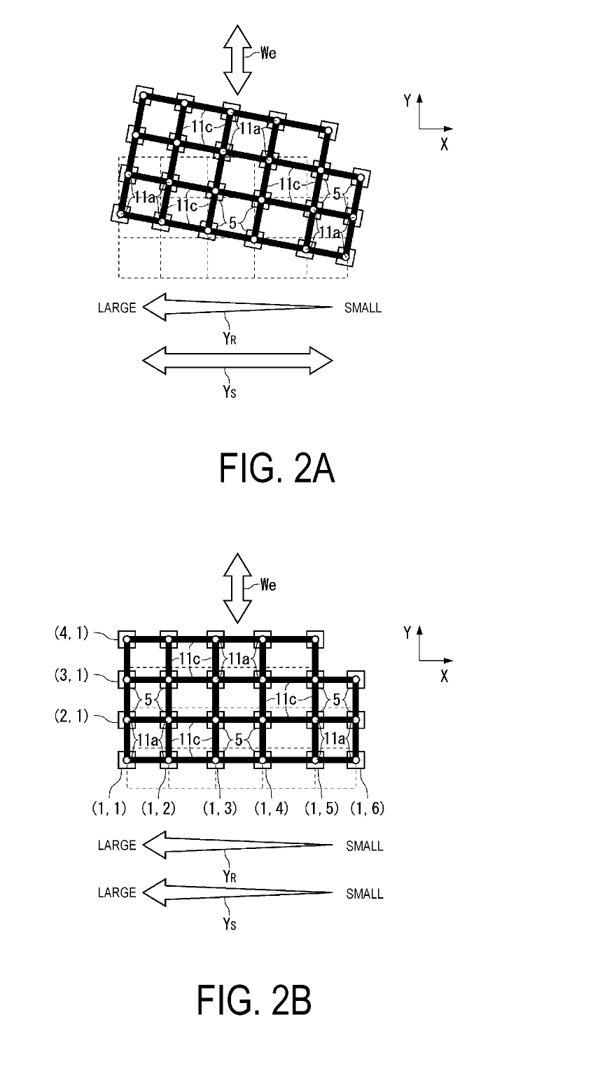

The boiler support steel frame 11 has characteristics in which the pillar leg reaction forces significantly differ depending on locations of the pillar legs 11b. This is because the boiler support structure 10, which includes the main boiler body 3, has anisotropy with respect to a load in the horizontal direction. Therefore, when the seismic isolation devices 5 that have the same rigidity are installed on the respective pillar legs 11b, the displacements of the seismic isolation devices 5 become different from each other, and as a result, a stable vibration mode cannot be obtained after seismic isolation. Specifically, when differences in the pillar leg reaction forces illustrated in FIG. 1B occur in the pillar legs 11b, the seismic isolation devices 5 are subject to a large displacement in sections in which the pillar leg reaction forces are large, and the seismic isolation devices 5 are subject to a small displacement in sections in which the pillar leg reaction forces are small. As a result, there is a possibility that a twisting vibration mode arises, as illustrated in FIG. 2A, for example.

Thus, as illustrated in FIG. 1B, by adjusting the rigidities Yₛ of the seismic isolation devices 5 that support the respective pillar legs 11b according to the magnitudes of the pillar leg reaction forces Y_{R}, the displacement amounts of the seismic isolation devices 5 in the respective pillar legs 11b can be caused to match. As a result, as illustrated in FIG. 2B, the boiler support structure 10 can vibrate integrally during an earthquake, and the effect of the seismic isolation is improved.

Note that directions of input seismic waves are as illustrated by arrows denoted by We in FIGS. 2A and 2B.

Depending on the boiler support structure 10, a tendency of the pillar leg reaction forces may be different from the tendency of the pillar leg reaction forces illustrated in FIG. 1B. Even in that case, by causing the rigidities of the seismic isolation devices 5 to be high in sections in which the pillar leg reaction forces are large and causing the rigidities of the seismic isolation devices 5 to be low in sections in which the pillar leg reaction forces are small, in order to correspond to the tendency, the displacement amounts of the seismic isolation devices 5 in the respective pillar legs 11b can be caused to match.

For example, in the examples illustrated in FIGS. 1A and 1B and FIGS. 2A and 2B, the case is explained in which the rigidities of the seismic isolation devices in the Y direction are adjusted while focusing on the pillar leg reaction forces occurring in the Y direction. However, in a case in which the pillar leg reaction forces in an X direction are different from each other, similarly to the case in the Y direction, it is only necessary to adjust the rigidities of the seismic isolation devices 5 in the X direction so as to cause the displacement amounts of the seismic isolation devices 5 in the X direction to be matched in the respective pillar legs 11b.

As described above, according to the first embodiment, it becomes possible to seismically isolate the main boiler body 3 located above the seismic isolation devices 5 and also the entire boiler support structure 10, and the effect of the seismic force on the support steel frame 11 can be significantly reduced.

Further, since the boiler support structure 10 can vibrate integrally during an earthquake, the effect of the seismic isolation is high.

Here, a proof stress Y_{P} can also be used as an index for the seismic isolation characteristics of the seismic isolation device 5, in addition to the rigidity Yₛ. Specifically, at the location at which the pillar leg reaction force Y_{R} is large, the seismic isolation device 5 with the large proof stress Y_{P} is installed, since a load applied to the seismic isolation device 5 (a load generated by the own weight of the support steel frame 11, a load generated during an earthquake, etc.) tends to become larger at that location. As a result, because the seismic isolation device 5 with the small proof stress Yₚ is adopted at the location at which the load acting upon the seismic isolation device 5 is small, there is no need to use a costly seismic isolation device that has a larger proof stress than necessary, and it is thus possible to reduce costs. However, normally, because the seismic isolation device 5 that has the higher rigidity Yₛ, tends to have the larger proof stress Y_{P}, when the arrangement of the seismic isolation devices 5 is adjusted on the basis of the magnitudes of the rigidities Yₛ, as illustrated in FIG. 1B, the seismic isolation device 5 that has the large proof stress Yₚ is naturally arranged in the section in which the pillar leg reaction force Y_{R} is large.

### [Second Embodiment]

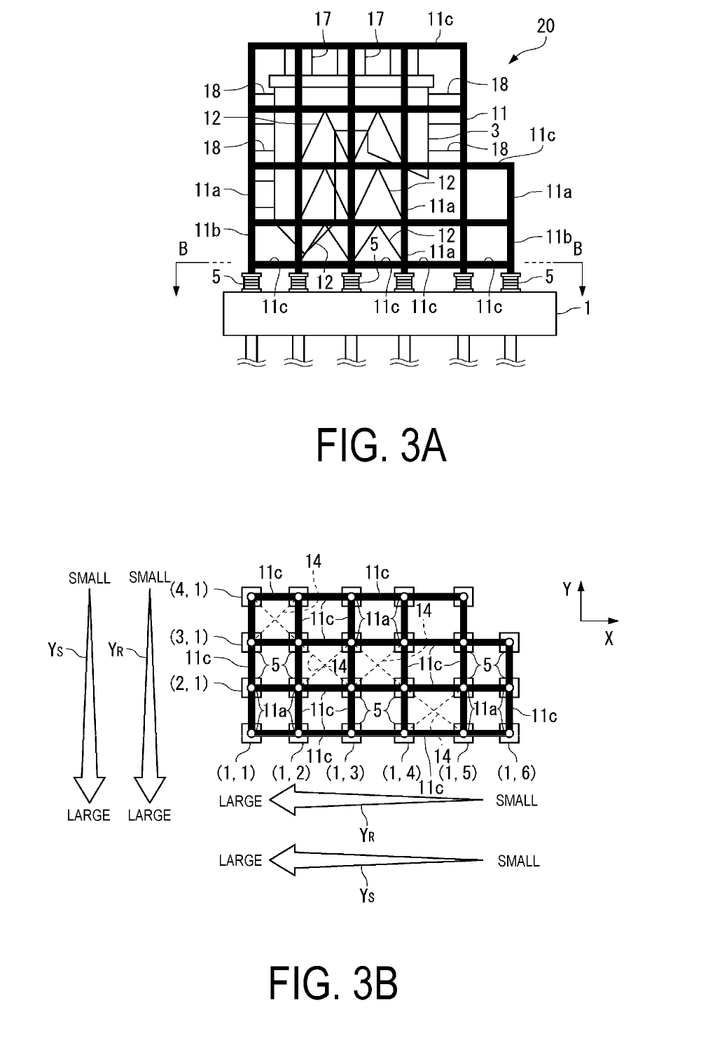

A boiler support structure 20 according to a second embodiment improves a horizontal rigidity of the above-described boiler support structure 10. Specifically, as illustrated in FIGS. 3A and 3B, the boiler support structure 20 connects the pillar legs 11b, which are supported by the seismic isolation devices 5, using connecting beams 11c, thereby improving the horizontal rigidity of the support steel frame 11. When the horizontal rigidity is insufficient with only the connecting beams 11c, horizontal braces 14 can also be provided.

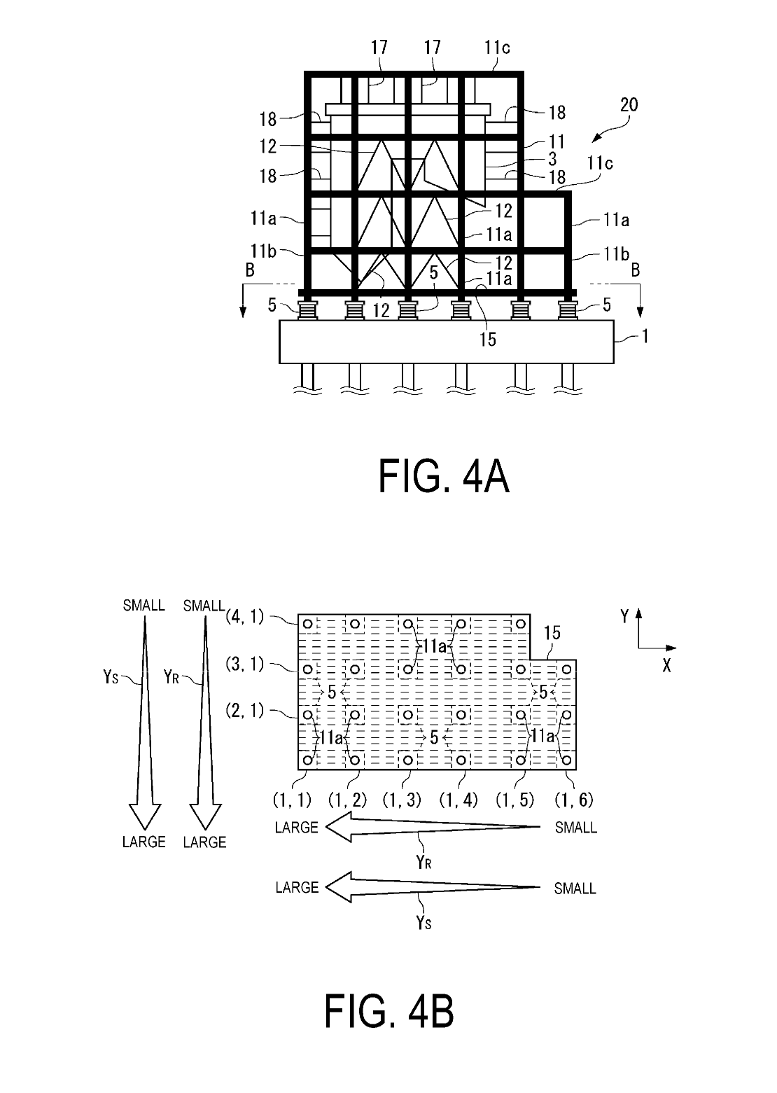

Further, in place of the connecting beams 11c, slabs 15 made of reinforced concrete (RC) can also be installed between the pillar legs 11b, as illustrated in FIGS. 4A and 4B.

As described above, by securing the horizontal rigidity of the support steel frame 11 by the connecting beams 11c or the slabs 15, the horizontal rigidity of the support steel frame 11 located above the seismic isolation devices 5 can be secured, and it becomes easier to obtain the vibration mode in which the entire boiler support structure 20 located above the seismic isolation devices 5 vibrates integrally. As a result, the effect of the seismic isolation can be further improved.

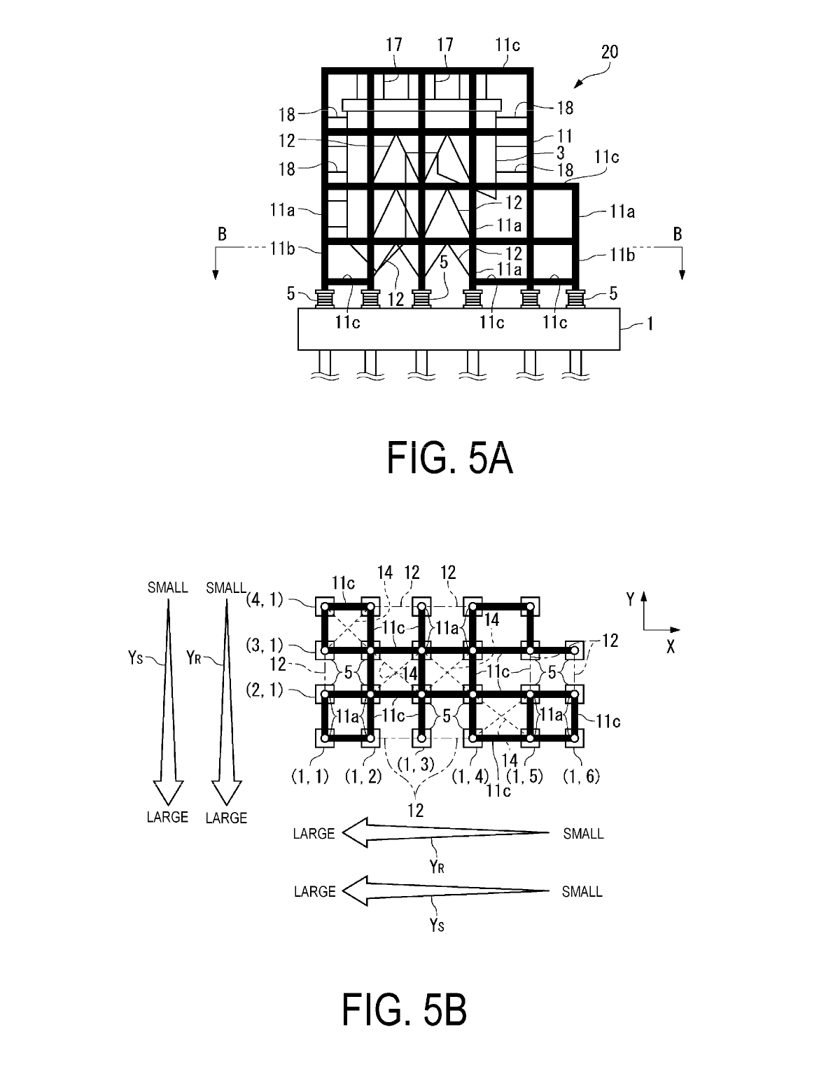

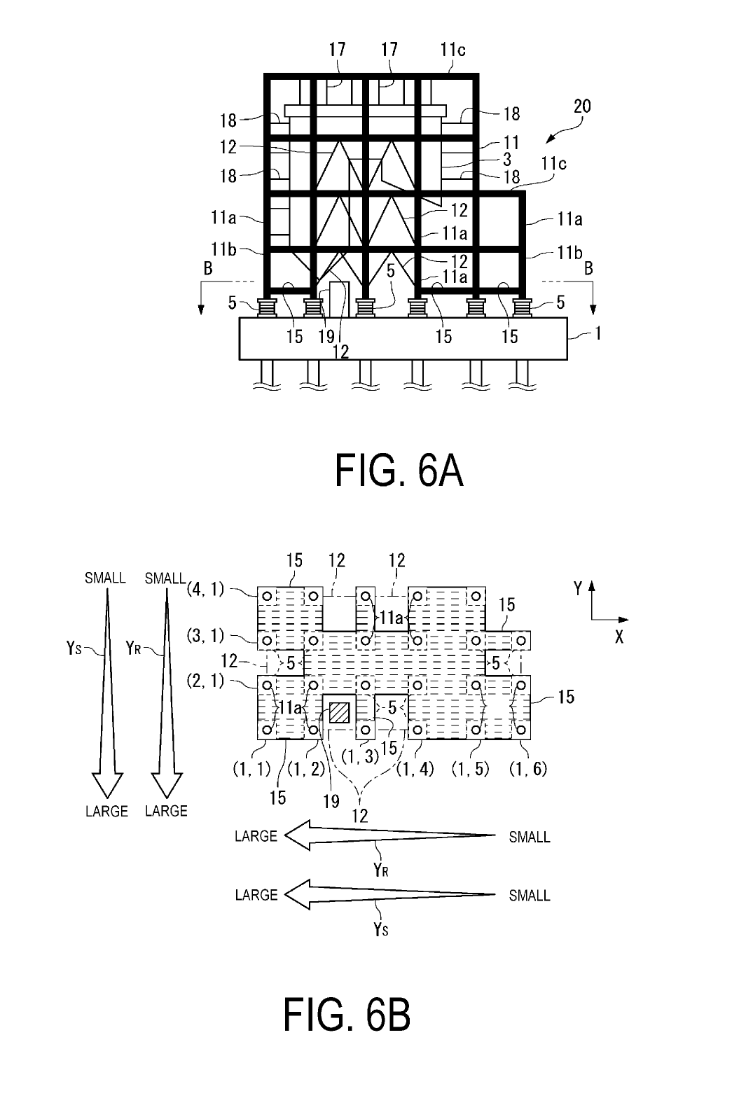

In an example illustrated in FIGS. 3A and 3B, the adjacent pillar legs 11b are all connected by the connecting beams 11c, and in an example illustrated in FIGS. 4A and 4B, the slabs 15 are installed on all of the adjacent pillar legs 11b. However, it is also possible to arrange the connecting beams 11c or the slabs 15 only in limited sections in which the horizontal rigidity is low. For example, as illustrated in FIGS. 5A and 5B and FIGS. 6A and 6B, there is an option not to arrange the connecting beams 11c or the slabs 15 in sections in which the horizontal rigidity is already high because the vertical braces 12 are installed therein. Further, when the pillars 11a (the pillar legs 11b) independently have a sufficient horizontal rigidity, there is an option not to install the connecting beams 11c or the slabs 15 that connect each of the pillars 11a. Because it is possible to verify whether or not a necessary level of the horizontal rigidity is secured for achieving seismic isolation through eigenvalue analysis, dynamic analysis, etc., optimum locations at which the connecting beams 11c or the slabs 15 are arranged can be identified based on those analysis results.

As described above, by arranging the connecting beams 11c or the slabs 15 only in the sections in which the horizontal rigidity is low, it is possible to reduce costs by reducing a material amount of the connecting beams 11c or the slabs 15. Further, those sections in which the connecting beams 11c or the slabs 15 are not installed can be used as a space for installing equipment or transporting materials, or as a space through which people can enter and exit. Thus, it is possible to provide the seismically isolated boiler support structure 20 without having a negative impact on the plant operation. FIGS. 6A and 6B illustrate an example in which equipment 19, which does not need to be seismically isolated, is installed in a section in which the slab 15 is not installed. Since the equipment 19 is directly installed on the foundation 1, the equipment 19 can avoid the impact of a relative displacement caused by the seismic isolation. The equipment 19 may be, for example, a coal pulverizer, or a fan.

### [Third Embodiment]

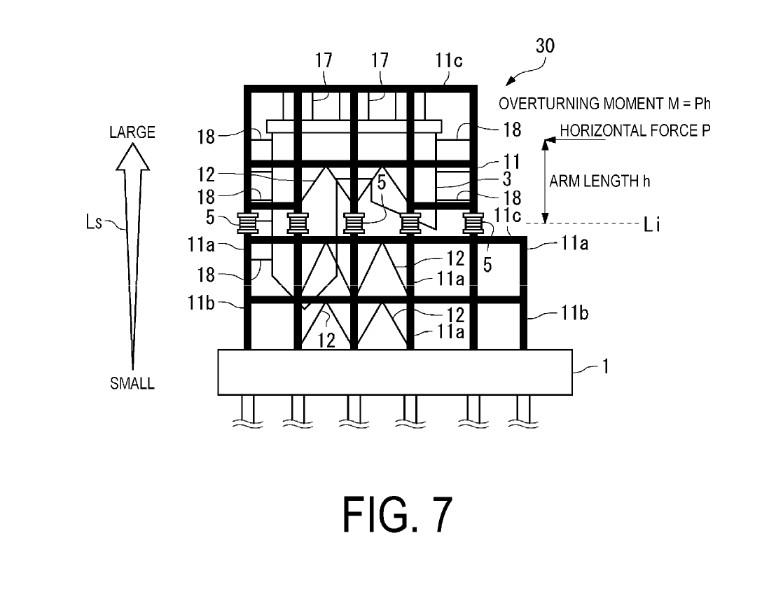

In a boiler support structure 30 according to a third embodiment, the seismic isolation devices 5 can be installed in an intermediate region in a height direction of the support steel frame 11 rather than between the foundation 1 and the pillar legs 11b, based on an assumption that the seismic isolation devices 5 that have high rigidities are installed in the sections in which the pillar leg reaction forces are large, and the seismic isolation devices 5 that have low rigidities are installed in the sections in which the pillar leg reaction forces are small. At this time, the base portions of the pillar legs 11b are directly fixed to the foundation 1. FIG. 7 illustrates an example in which the seismic isolation devices 5 are arranged in the intermediate region. Note that, in FIG. 7, the same elements as in the first embodiment are assigned with the same reference signs as used in FIGS. 1A and 1B.

It is preferable to decide locations at which the seismic isolation devices 5 are installed after considering a balance of loads occurring in each of the supports 18. Specifically, taking into consideration the fact that loads Ls occurring in the supports 18 provided in the upper portion of the support steel frame 11 tend to be large, as illustrated in FIG. 7, the seismic isolation devices 5 are provided above the lower portion, in which the loads Ls are small. As a result, it is possible to seismically isolate the portion above the supports 18, in which the loads Ls are large, in a selective manner.

When the horizontal rigidity of locations above the locations at which the seismic isolation devices 5 are provided is insufficient, the adjacent pillars 11a may be connected by the connecting beams 11c, as illustrated in FIG. 7. In addition, the slabs 15 may be provided instead of the connecting beams 11c. Also, when the horizontal rigidity of locations below the intermediate seismic isolation devices is insufficient, the connecting beams 11c or the slabs 15 may be provided in the same manner. Further, in place of the connecting beams 11c, the vertical braces 12 may be installed. Furthermore, it is preferable to provide the supports 18 below the locations at which the seismic isolation devices 5 are provided, as this can suppress the relative displacement between the main boiler body 3 and the support steel frame 11. Also, in addition to or in place of the supports 18, energy absorption mechanisms 16, which will be described below, can be provided below the locations at which the seismic isolation devices 5 are provided.

The boiler support structure 30 that supports the main boiler body 3 is a top heavy structure in which the loads Ls tend to become larger toward the upper portion. Thus, the effect of reducing the seismic force can be sufficiently obtained even with the present embodiment in which only the upper portion is seismically isolated by providing the intermediate seismic isolation devices.

Further, by installing the seismic isolation devices at locations higher than the base portions of the pillar legs 11b, an arm length h of an overturning moment M of the seismic isolation device, which arises due to an inertia force occurring during an earthquake, is reduced, as stated in FIG. 7. As a result, tensile forces occurring in the seismic isolation devices 5 are reduced, and it becomes possible to apply the seismic isolation devices 5 to the boiler support structure 30 that has the large overturning moment M during the earthquake, such as a large boiler.

The method to improve the horizontal rigidity described in the second embodiment can also be applied to the third embodiment. Specifically, when the horizontal rigidity of the support steel frame 11 positioned above or below the locations at which the seismic isolation devices 5 are arranged (a seismic isolation layer) is insufficient, rigid members may be arranged in a specific region or an entire region positioned above or below the seismic isolation layer or both above and below the seismic isolation layer. As a result, it becomes possible to secure the horizontal rigidity of the support steel frame 11 positioned above and below the seismic isolation devices 5, and it becomes easier to obtain the vibration mode in which each portion of the boiler support structure 30 above and below the seismic isolation devices 5 vibrates integrally. As a result, the effect of the seismic isolation can be further improved. As the rigid members, connecting beams that connect each of the pillars or the horizontal braces may be used.

### [Fourth Embodiment]

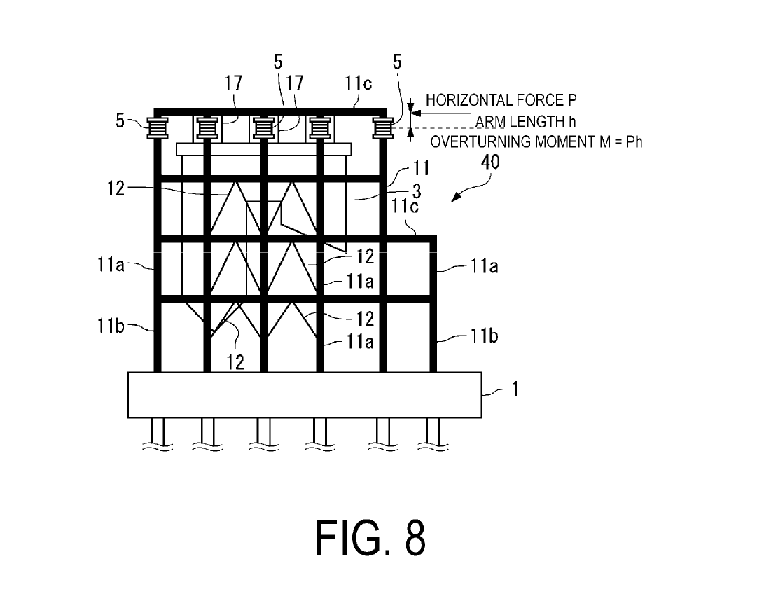

In a boiler support structure 40 according to a fourth embodiment, the seismic isolation devices 5 are installed in the top portion of the support steel frame 11 so as to be placed at positions higher than the positions in the third embodiment, as illustrated in FIG. 8. Note that, in FIG. 8, the same elements as in the first embodiment are assigned with the same reference signs as used in FIGS. 1A and 1B. The boiler support structure 40 is not provided with the supports 18 that play a role of transmitting a load between the main boiler body 3 and the support steel frame 11 in the horizontal direction.

In a structure that supports the main boiler body 3 in a suspended state in only the top portion of the support steel frame 11, it becomes possible to reduce the inertia force of the main boiler body 3 that acts upon the support steel frame 11 during an earthquake by installing the seismic isolation devices 5 in the top portion as in the boiler support structure 40. Here, since the supports 18 are not provided in the boiler support structure 40, the boiler support structure 40 has a structure in which all the inertia force of the main boiler body 3 is transmitted to the support steel frame 11 via the seismic isolation devices. Thus, by seismically isolating the top portion, as in the boiler support structure 40, the inertia force of the main boiler body 3 transmitted to the support steel frame 11 is reduced. As a result, a seismic load that acts upon the support steel frame 11 can be reduced.

Further, since the positions of the seismic isolation devices are even higher than in the third embodiment, the arm length h becomes shorter, as stated in FIG. 8, thereby further reducing the overturning moment M occurring in the seismic isolation devices 5 during an earthquake. As a result, it becomes possible to apply the seismic isolation devices 5 to the support steel frame 11 in which the overturning moment M is extremely large.

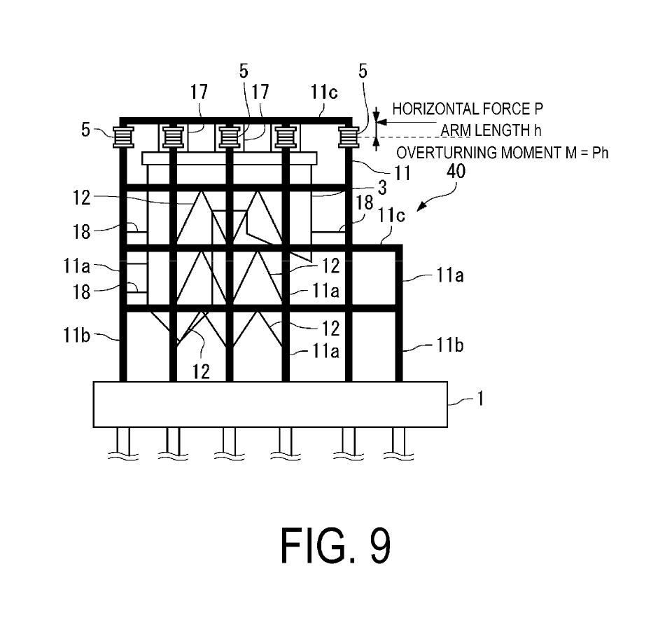

Although the supports 18 are not provided in the boiler support structure 40 illustrated in FIG. 8, the supports 18 can be provided in the boiler support structure 40 at appropriate locations between the main boiler body 3 and the support steel frame 11, as illustrated in FIG. 9.

By providing the supports 18 in the boiler support structure 40, the following effects can be achieved.

Since the supports 18 are not provided in the third embodiment, a large relative displacement may occur between the main boiler body 3 and a portion of the support steel frame 11, which is located below the seismic isolation devices 5, during an earthquake. Thus, in order to prevent this relative displacement from affecting peripheral equipment of the main boiler body 3, such as piping, the supports 18 are provided between the main boiler body 3 and the support steel frame 11 so as to secure the horizontal rigidity, as illustrated in FIG. 9, thereby suppressing the relative displacement between the main boiler body 3 and the support steel frame 11.

Further, in the boiler support structure 40 illustrated in FIG. 8, a natural frequency at which the main boiler body 3 vibrates and the natural frequency of the entire boiler support structure 40 become close to each other, and there are some cases in which the effect of the seismic isolation cannot be sufficiently achieved just as it is. Thus, as illustrated in FIG. 9, a cycle of the natural frequency of the main boiler body 3 is shortened by installing the supports 18. As a result, it is possible to prevent the natural frequency of the main boiler body 3 and the natural frequency of the entire seismically isolated boiler support structure 40 from becoming close to each other, and the effect of the seismic isolation in the boiler support structure 40 can be sufficiently exploited.

The method to improve the horizontal rigidity described in the second embodiment can also be applied to the fourth embodiment. Specifically, when the horizontal rigidity of the support steel frame 11 positioned above or below the locations at which the seismic isolation devices 5 are arranged (a seismic isolation layer) is insufficient, rigid members may be arranged in a specific region or an entire region positioned above or below the seismic isolation layer or both above and below the seismic isolation layer. As a result, it becomes possible to secure the horizontal rigidity of the support steel frame 11 positioned above and below the seismic isolation devices 5, and it becomes easier to obtain the vibration mode in which the portions of the boiler support structure 30 above and below the seismic isolation devices 5 vibrate integrally. As a result, the effect of the seismic isolation can be further improved. As the rigid members, connecting beams that connect each of the pillars or the horizontal braces may be used.

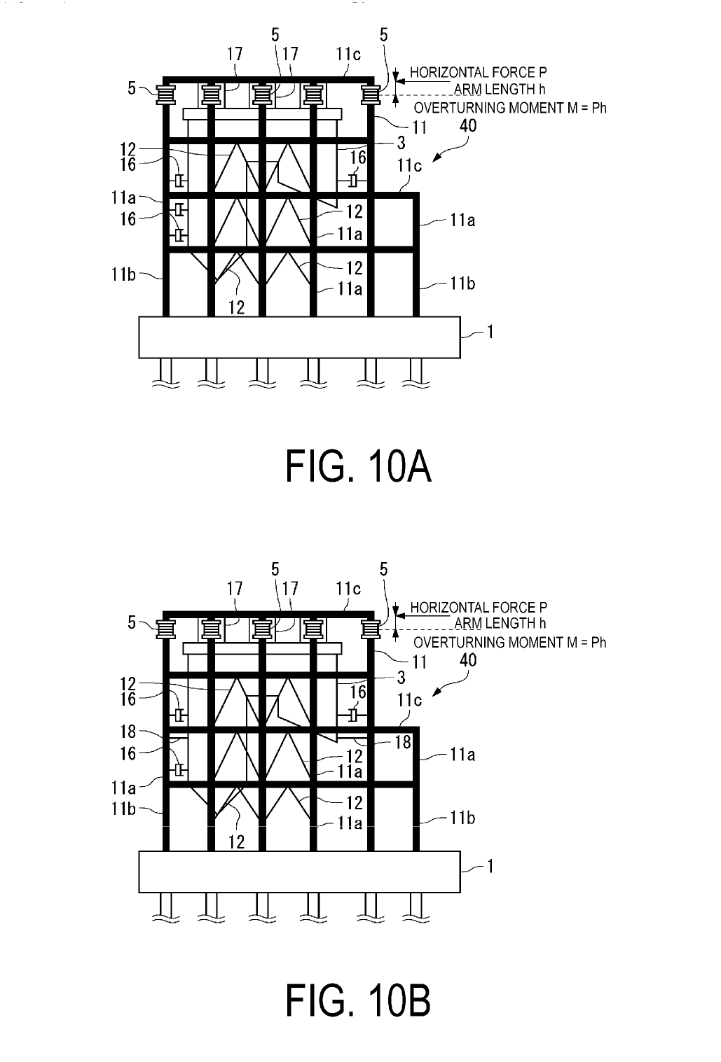

In the fourth embodiment, the energy absorption mechanisms 16 may be provided in place of the supports 18, as illustrated in FIGS. 10A and 10B. The energy absorption mechanisms 16 can be substituted for all the plurality of supports 18 provided (FIG. 10A) or can be substituted for some of the plurality of supports 18 provided (FIG. 10B). Note that it is sufficient that the energy absorption mechanism 16 be provided with a function to absorb energy during an earthquake, and, for example, an oil damper, a steel damper, a lead damper, or the like can be used as the energy absorption mechanism 16.

As illustrated in FIGS. 10A and 10B, a damping function is imparted by installing the energy absorption mechanisms 16. As a result, it becomes possible to suppress the excessive relative displacement between the main boiler body 3 and the support steel frame 11, and at the same time, compared with a case in which the supports 18 are provided, the inertia force of the main boiler body 3 in the horizontal direction, which acts upon the support steel frame 11 during an earthquake, can be further reduced.

The embodiments of the present invention have been described above. However, as long as there is no departure from the spirit and scope of the present invention, configurations described in the above embodiments can be selected as desired, or can be changed to other configurations as necessary.

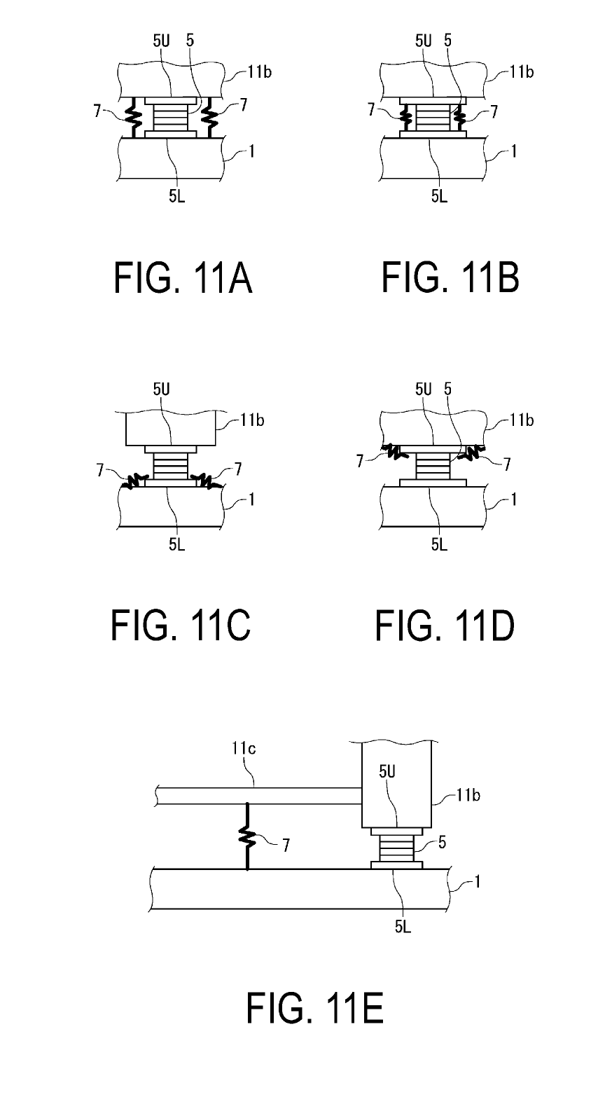

In the first embodiment, it is possible to provide a pull-out prevention mechanism 7, as illustrated in FIGS. 11A to 11E, which bears the tensile force during an earthquake in a space generated as a result of providing the seismic isolation device 5 between the foundation 1 and the pillar legs 11b. The pull-out prevention mechanism 7 is capable of bearing the tensile force, which occurs in the seismic isolation device 5, in place of the seismic isolation device 5.

As illustrated in FIGS. 11A to 11E, the pull-out prevention mechanism 7 is provided by causing a desired member that can achieve the intended function to form a connection between the foundation 1 and the pillar leg 11b (FIG. 11A), between an upper flange 5U of the seismic isolation device 5 and a lower flange 5L of the seismic isolation device 5 (FIG. 11B), between the foundation 1 and the lower flange 5L of the seismic isolation device 5 (FIG. 11C), between the pillar leg 11b and the upper flange 5U of the seismic isolation device 5 (FIG 11D), between the foundation 1 and the connecting beam 11c (FIG. 11E), or the like.

As a result of the pull-out prevention mechanism 7 bearing the tensile force occurring in the seismic isolation device during an earthquake, the tensile force occurring in the seismic isolation device 5 itself can be reduced. As a result, it becomes possible to apply the seismic isolation devices 5 to a structure that has a large overturning moment M during an earthquake, such as a large boiler.

The pull-out prevention mechanism 7 can also be applied to the second embodiment. In this case, the pull-out prevention mechanism 7 can be provided in a desired position, such as between the adjacent beams 11c that sandwich the seismic isolation device 5 from above and below, between the lower flange 5L of the seismic isolation device 5 and the beam 11c positioned below the seismic isolation device 5, or the like.

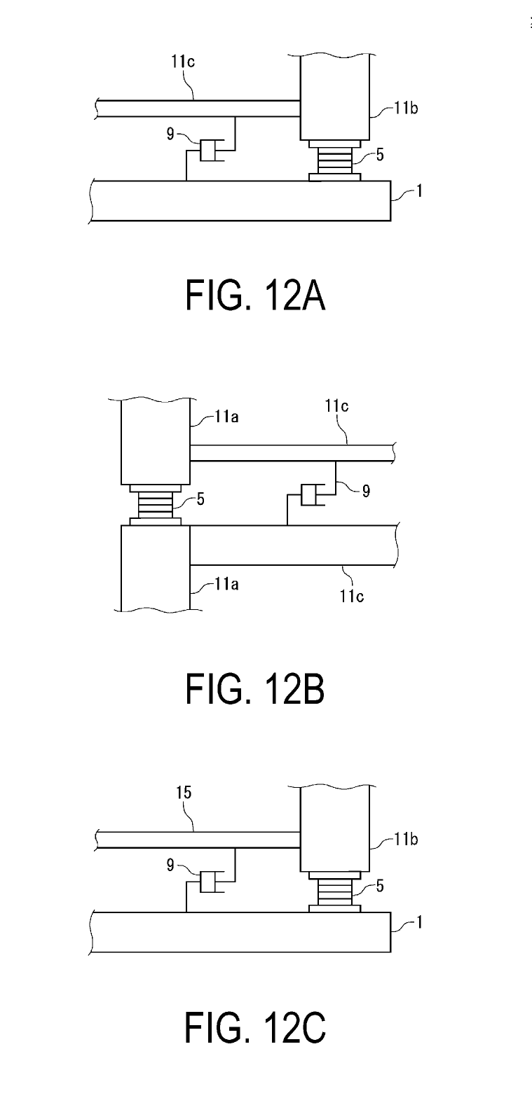

Further, in the first to third embodiments, it is possible to provide an energy absorption mechanism 9 in a space generated as a result of providing the seismic isolation device 5, as illustrated in FIGS. 12A to 12C. This energy absorption mechanism 9 can be formed by an oil damper or the like in the same manner as the above-described energy absorption mechanism 16.

As illustrated in FIGS. 12A to 12C, the energy absorption mechanism 9 is provided by causing a desired member that can achieve the intended function to form a connection between the foundation 1 and the connecting beam 11c (FIG. 12A), between the beam 11c of the support steel frame 11 and the connecting beam 11c (FIG. 12B), between the foundation 1 and the slab 15 (FIG. 12C), or the like.

As a result of imparting a damping effect on the boiler support structures 10 to 30 by providing the energy absorption mechanism 9, it is possible to further reduce the seismic force that acts upon the support steel frame 11. Further, it is also possible to suppress the excessive displacement of the seismic isolation devices during an earthquake.

Further, the seismic isolation devices 5 that are used in the present invention may adopt any seismic isolation method as long as the characteristics of the seismic isolation devices 5 can be set in accordance with the pillar leg reaction forces of the pillar legs 11b so as to cause all the seismic isolation devices 5 to behave in synchrony. The seismic isolation device normally has two functions as an isolator and a damper. Thus, as the seismic isolation device, various types of seismic isolation devices that are provided with those two functions can be used, including a sliding base-combined hybrid seismic isolation system, a laminated rubber bearing system containing a lead plug, a high damping laminated rubber bearing system, and the like.

Further, a specific configuration of the support steel frame 11 illustrated in the above-described embodiments is only an example. The number and combination of the pillars 11a, the beams 11c, the vertical braces 12, and the connecting beams 11c can be determined as necessary.

Furthermore, in the above-described embodiments, an example is illustrated in which one of the pillars 11a is supported by one of the seismic isolation devices 5. However, when a gap between the adjacent pillars 11a is narrow, a plurality of the pillars 11a, such as two of the pillars 11a, for example, can be supported by one of the seismic isolation devices 5.

### REFERENCE SIGNS LIST

1 Foundation
3 Main boiler body
5 Seismic isolation device
5L Lower flange
5U Upper Flange
7 Pull-out prevention mechanism
9 Energy absorption mechanism
10, 20, 30, 40 Boiler support structure
11 Support steel frame
11a Pillar
11b Pillar leg
11c Beam
12 Vertical brace
14 Horizontal brace
15 Slab
16 Energy absorption mechanism
17 Suspension bar
18 Support
19 Equipment

1. A boiler support structure, comprising:
a main boiler body;
a support steel frame that supports the main boiler body in a suspended state, the support steel frame including a plurality of pillars that each stand on a foundation with a pillar leg placed therebetween and a plurality of beams that connect the adjacent pillars; and
a seismic isolation device that supports at least one of the plurality of pillars;
seismic isolation characteristics of the seismic isolation device being set in accordance with magnitudes of horizontal reaction forces occurring in the plurality of pillars.

2. The boiler support structure according to claim 1, wherein
the seismic isolation device is provided between the foundation and one of the pillar legs.

3. The boiler support structure according to claim 1, wherein
the seismic isolation device is provided in an intermediate region, in a height direction, of the support steel frame.

4. The boiler support structure according to claim 1, wherein
the seismic isolation device is provided in a top portion of the support steel frame.

5. The boiler support structure according to claim 2, wherein
a rigid member for securing a horizontal rigidity of the pillar legs is installed in a specific section or an entire section of the support steel frame in a horizontal direction.

6. The boiler support structure according to claim 3, wherein
a rigid member for securing a horizontal rigidity of the pillar legs is installed in a specific section or an entire section of the support steel frame in a horizontal direction.

7. The boiler support structure according to claim 4, wherein
a rigid member for securing a horizontal rigidity of the pillar legs is installed in a specific section or an entire section of the support steel frame in a horizontal direction.

8. The boiler support structure according to claim 3, wherein
a support for suppressing a relative displacement between the main boiler body and the support steel frame is installed between the main boiler body and the support steel frame.

9. The boiler support structure according to claim 4, wherein
a support for suppressing a relative displacement between the main boiler body and the support steel frame is installed between the main boiler body and the support steel frame.

10. The boiler support structure according to claim 3, wherein
an energy absorption mechanism is installed between the main boiler body and the support steel frame.

11. The boiler support structure according to claim 4, wherein
an energy absorption mechanism is installed between the main boiler body and the support steel frame.

12. The boiler support structure according to claim 2, wherein
a pull-out prevention mechanism that bears a tensile force occurring in the seismic isolation device is installed along with the seismic isolation device.

13. The boiler support structure according to claim 3, wherein
a pull-out prevention mechanism that bears a tensile force occurring in the seismic isolation device is installed along with the seismic isolation device.

14. The boiler support structure according to claim 1, wherein
an energy absorption mechanism is installed along with the seismic isolation device.

15. The boiler support structure according to claim 1, wherein
in the seismic isolation device, different seismic isolation characteristics are set in accordance with the magnitudes of the horizontal reaction forces occurring in the plurality of pillars.
